(19) United States
(12) Patent Application Publication
(10) Pub. No.: US 2025/0112321 A1
(43) Pub. Date: Apr. 3, 2025

(54) HOUSING DEVICE FOR A BATTERY CELL, BATTERY CELL SYSTEM AND MOTOR VEHICLE

(71) Applicant: AUDI AG, Ingolstadt (DE)

(72) Inventors: Carsten LORENZ, Reichertshofen (DE); Thomas MILDE, Wüstenrot (DE); Julius RAUSCH, Heilbronn (DE); Paul SCHNEIDER, Großmehring (DE)

(73) Assignee: AUDI AG, Ingolstadt (DE)

(21) Appl. No.: 18/888,275

(22) Filed: Sep. 18, 2024

(30) Foreign Application Priority Data
Sep. 29, 2023 (DE) 102023126638.1

(51) Int. Cl. H01M 50/342; B60L 50/64; H01M 50/103

(52) U.S. Cl. CPC H01M 50/3425; B60L 50/64; H01M 50/103; H01M 2220/20

(57) ABSTRACT

A housing device for a battery cell, including a housing adapted to enclose a battery cell, a first local weakening adapted to yield at a first pressure generated by the battery cell, and a second local weakening arranged at least partially above the first local weakening and adapted to yield at a second pressure generated by the battery cell. The second pressure is lower than the first pressure

### FIELD

The invention relates to a housing device for a battery cell and to a motor vehicle with such a housing device.

### BACKGROUND

Battery cells are usually arranged in a stack and interconnected to create a high-voltage battery. Malfunctions and/or incorrect operation of an individual battery cell can cause hot gases and particles to escape. These can then also heat other battery cells, especially those arranged next to them, causing a chain reaction known as thermal runaway or expansion.

### SUMMARY

It is therefore an object to specify an improved housing device for a battery cell, a battery cell system consisting of multiple housing devices and a motor vehicle with such a housing device and/or such a battery cell system.

According to a first aspect, a housing device for a battery cell is provided.

The housing device according to the invention comprises a housing which is designed to enclose a battery cell, a first local weakening which is designed to yield at a first pressure generated by the battery cell, and a second local weakening which is arranged at least partially above the first local weakening and which is designed to yield at a second pressure generated by the battery cell, the second pressure being lower than the first pressure.

The housing device according to the invention serves in particular to safely discharge a pressure from the inside of the housing, which is generated by a battery cell, from the housing and, in reverse, to prevent it from penetrating into the housing and thus into the battery cell in relation to a pressure acting on the housing from the outside. In particular, the housing device according to the invention serves to prevent or at least reduce thermal propagation, i.e. the spread of heat, between multiple housing devices or battery cells.

The housing device according to the invention initially comprises a housing which is designed to enclose a battery cell.

A battery cell is an electrical energy storage that stores electrical energy on an electrochemical basis. In particular, the battery cell is an accumulator so that it can be recharged. For example, the battery cell is a battery based on lithium or a lithium compound, in particular lithium ions, and can also be referred to as a lithium-ion accumulator. Typical examples of such a lithium-ion accumulator are lithium-cobalt dioxide accumulators, lithium-manganese accumulators, lithium-nickel-manganese-cobalt accumulators, lithium-nickel-cobalt-aluminum accumulators and/or lithium-iron-phosphate accumulators.

In particular, the housing completely encloses a battery cell, i.e. on all sides, with the exception of the first and second local weakening described below. In particular, the housing can be rectangular in shape and have four side surfaces as well as a bottom and a top surface, all of which are arranged essentially at right angles to each other.

In particular, the housing can be made of a solid and/or hard material, such as metal, especially aluminum. In particular, the housing is made of a material that does not yield, crack and/or burst under both the first and the second pressure that is formed in the battery cell, as will be described below.

In particular, the housing can have a greater extension in the direction of a height and a depth than in a width, resulting in two larger and in particular equally large, for example rectangular or square, side surfaces and four smaller and in particular equally large, for example rectangular, further surfaces of the housing, of which, for example, two further surfaces can be designated as side surfaces and one further surface each as a top and bottom surface.

The housing device also comprises a first local weakening adapted to yield at a first pressure generated by the battery cell, and a second local weakening disposed at least partially over the first local weakening and adapted to yield at a second pressure generated by the battery cell, the second pressure being less than the first pressure.

A local weakening is a feature in the housing where there is less material than outside the local weakening or around it. The local weakening can be formed by a thinner housing wall and/or a perforation or interruption in the material.

In the present case, yielding means in particular breaking, especially breaking and/or cracking, folding open, opening and/or bursting.

In particular, the first and second local weakening are the only two weakenings of the housing or the housing is weakest at the first and, in particular, the second local weakening or yields most easily or first there.

The first local weakening can also be referred to as a valve, valve opening, vent and/or vent opening, whereas the second local weakening can be referred to as a protective cover, which protects the vent opening from unintentional opening, in particular by external influences, such as an adjacent battery cell, as will be described later.

A pressure in the housing can be generated, for example, by a malfunction and/or incorrect operation of the battery cell, resulting in an overpressure inside the battery cell or housing compared to the normal pressure prevailing in the environment. For example, a malfunction of the battery cell generates gases that have to escape from the housing. This occurs in a controlled manner first via the first local weakening and then via the second local weakening.

For this purpose, the first and second local weakening are arranged at least partially, in particular predominantly, further in particular completely overlapping one another or one above the other in or on the housing. For example, the first and second local weakenings have an overlap of at least 50%, 60%, 70%, 80%, 90%, 95% or 100%.

In particular, the first local weakening and the second local weakening are arranged relative to one another in such a way that they are essentially in direct contact along a height and/or have a distance of less than 5 mm, 4 mm, 3 mm, 2 mm or 1 mm from one another.

The first and second localized weakening may have a similar or identical cross-section, a similar or identical shape and/or similar or identical external extensions, measurements and/or dimensions. For example, the first and second local weakening are essentially circular, oval, elliptical or rectangular, in particular with or without rounded corners, as will be described further on.

In particular, the first and second local weakening are arranged and designed with respect to each other in such a way that the first local weakening initially yields due to a pressure that builds up inside the housing, for example due to the battery cell, or is generated there. For this purpose, the local weakening is designed in such a way that it yields at a first, predetermined pressure and releases the pressure, which may in particular also include hot gases and/or particles from the battery cell, in the present case in particular predominantly or exclusively on the second local weakening.

This second local weakening then also gives way, in this case at a second predetermined pressure that is lower than the first pressure.

For example, the first pressure is an integer multiple greater than the second pressure, in particular at least a twofold, fivefold or tenfold greater than the second pressure. For example, the first pressure is 2 bar, 3 bar, 5 bar, 7 bar, 9 bar, 10 bar or greater and/or the second pressure is 1 bar, 900 mbar, 700 mbar, 500 mbar, 300 mbar, 100 mbar or less.

In particular, the first and second local weakening can be arranged in one of the smaller surfaces, in particular the top or bottom surface. In other words, in particular the first local weakening and the second local weakening are arranged and formed in a surface of the housing which has a smaller area than at least two other sides and in particular has the smallest extent of the housing.

In particular, the first local weakening and the second local weakening are arranged on or along the underside of the housing or the housing device, likewise in particular on an opposite side of any connecting elements of the housing device. Further in particular, the housing device is arranged in a motor vehicle in such a way that the first local weakening and the second local weakening are arranged in the direction of an underside and in particular of an underbody, such as an underride guard, and yield in particular in this direction, whereby a pressure and in particular a gas and/or particle flow is also directed in this direction.

In particular, the housing device according to the invention can comprise a battery cell as described above. In particular, the housing device can serve as a housing device for a prismatic cell or form such a prismatic cell together with the battery cell. In particular, multiple housings or housing devices can form a battery cell housing system if these are adjoining one another, in particular next to one another, further in particular on one or both of the respective larger side surfaces in relation to one another, as will be described in the further course. The battery cell housing system can also comprise multiple battery cells and thus form a battery cell system.

The housing device according to the invention makes it possible to safely discharge pressure from the inside of the housing, which is generated by a battery cell, from the housing and, in relation to pressure acting on the housing from the outside, to prevent it from penetrating into the housing and thus into the battery cell. In particular, the housing device according to the invention serves to prevent or at least reduce thermal propagation, i.e. the spread of heat, between multiple housing devices or battery cells.

According to a development, the second local weakening has a predetermined breaking point.

A predetermined breaking point is a point, a location and/or a position in or at which a break, should it occur, is desired to occur. In particular, a location or position of yielding is controlled, predefined or determined by the predetermined breaking point. The second local weakening can also be referred to as a predetermined breaking point as a whole. In particular, the second local weakening can also have multiple individual or spaced-apart predetermined breaking points, which may together form a contiguous predetermined breaking point.

Optionally, the first local weakening can also have one or more such predetermined breaking points.

The predetermined breaking point or predetermined breaking points are created in particular by punching out and/or perforating or by removing material in some other way.

This further development enables particularly fast and efficient gas removal from the inside of the housing.

According to a further development, the second local weakening has an essentially rectangular shape, with at least one side of the rectangular shape being designed as a predetermined breaking point.

In particular, the second local weakening has a shape and/or proportion corresponding to the surface, in particular the bottom surface, in which it is arranged. For example, the longer side of the rectangle of the local weakening can be arranged along the longer side of the rectangular bottom surface and the shorter side of the rectangle of the local weakening can be arranged along the shorter side of the rectangular bottom surface or parallel thereto.

The predetermined breaking point follows one of the sides of the rectangle or coincides with it. For example, at least one of the short and/or long sides of the rectangle of the local weakening can be designed as a predetermined breaking point and open outwards or at least deform when pressure is released from the inside of the housing.

Alternatively or additionally, the rectangular second local weakening also has a predetermined breaking point running parallel to one of the sides, which coincides, for example, with a central normal of one side and thus provides a central or central opening.

This further development enables particularly fast and efficient gas removal from the inside of the housing.

According to a further development, at least two sides of the rectangular shape are designed as a predetermined breaking point.

In particular, these can be opposite sides of the rectangular shape, especially the short sides of the rectangle.

In addition to the fact that two sides of the rectangle of the second local weakening are designed as a predetermined breaking point, a further, third predetermined breaking point can also be provided, which runs parallel to one of the sides, in particular to the long side or sides, and coincides, for example, with a central normal of a short side, thus providing a central or centered opening.

Alternatively or additionally, a further, fourth predetermined breaking point can be provided which runs parallel to one of the sides, in particular the short side or sides, and also coincides with a central normal of a long side, thus providing a further central or centered opening which, together with the third predetermined breaking point, can be designed as a central cross-shaped predetermined breaking point.

This further development enables particularly fast and efficient gas removal from the inside of the housing.

According to a further development, at least three sides of the rectangular shape are designed as a predetermined breaking point.

In particular, according to this development, one of the long sides and both short sides of the rectangle are designed as a predetermined breaking point. Alternatively, one of the short sides and both long sides of the rectangle are designed as a predetermined breaking point.

This further development enables particularly fast and efficient gas removal from the inside of the housing.

According to a further development, all sides, i.e. all four sides of the rectangular shape, are designed as predetermined breaking points.

In addition to the fact that all four sides of the rectangle of the second local weakening are designed as a predetermined breaking point, a further, fifth predetermined breaking point can also be provided, which runs parallel to one of the sides and coincides, for example, with a central normal of one side, thus providing a central or central opening.

This further development enables particularly fast and efficient gas removal from the inside of the housing.

According to a further development, the housing device further comprises a sealing element which extends over the second local weakening and seals it.

In particular, the sealing element extends completely over the entire second local weakening and/or all predetermined breaking points of the second local weakening.

The sealing element has two functions. On the one hand, it is intended to ensure that no external influences, such as from an adjacent battery cell, can penetrate into the interior of the housing or housing device and thus damage the battery cell inside, particularly in the region of the predetermined breaking points.

On the other hand, it is intended to fasten a yielding element of the second local weakening, for example the rectangle, to the housing or the housing device in such a way that although an opening of the second local weakening is made possible, for example by folding it open, this yielding element remains fastened to the housing and is thus captive.

In particular, the sealing element is arranged between the first and second local weakening and/or on the inner or upper side of the second local weakening.

The sealing element can be formed in multiple ways. For example, the sealing element can be designed as a film that extends over the second local weakening and/or the predetermined breaking points of the same and holds them together.

Alternatively or additionally, the sealing element can be formed as a local accumulation of material, which is formed by not completely removing the material. In particular, the material of the second local weakening can be a thermoplastic material, such as plastic, whereby the sealing element can be produced by heating after punching out or removing material from the predetermined breaking points.

In particular, the material of the second local weakening can be a fiber composite material, which in particular has a plastic matrix. A continuous fiber reinforcement can optionally be provided. The second local weakening can be produced in an injection molding process or a pressing process, for example.

In particular, the sealing element can be designed to seal the interior of the housing or the housing device and, in particular, the battery cell in an airtight and/or gas-tight manner.

For example, the predetermined breaking points have initially become gas-permeable due to the removal of material, whereas the sealing element restores the gas-tightness of the housing or housing device.

This further development enables particularly safe gas removal from the inside of the housing and prevents gas from entering from other battery cells.

According to a further development, the second local weakening is offset towards the first local weakening in relation to the rest of the housing.

In particular, the second local weakening is offset inwards towards an outer contour of the housing and/or towards the first local weakening. This offset can also be referred to as a recess.

This further development is particularly efficient in preventing gas entering from other battery cells, as the second local weakening can support itself against the first local weakening when pressure is applied from below and can only give way when the opposite pressure is applied from the inside.

According to a further development, the first local weakening consists of a different material than the second local weakening.

For this purpose, the first local weakening comprises different materials than the second local weakening. In particular, the first material has a different melting point from the second material.

As described above, the second local weakening can be made of a thermoplastic material, whereas the first local weakening can be made of a metal, in particular aluminum. In particular, the first local weakening can be made of a material identical to the housing and/or, in particular, be formed integrally therewith, whereas the second local weakening is formed differently or separately therefrom.

In particular, the first local weakening is made of the same material as the housing, whereas the second local weakening is made of another, second material.

This further development prevents gas entering from other battery cells particularly efficiently, as the second local weakening has different material properties than the first local weakening and thus reacts differently to thermal stress.

According to a further aspect, a battery cell system is disclosed comprising at least two housing devices according to one of the previously described embodiments, which are arranged side by side, in particular along the large side surfaces, wherein each of the housing devices can comprise a battery cell.

According to a still further aspect, a motor vehicle is disclosed which comprises a housing device and/or a battery cell system according to one of the embodiments described above. For example, the battery cell system serves as an energy storage of the motor vehicle, which can in particular be designed as a purely battery-electric and/or hybrid motor vehicle.

The motor vehicle according to the invention is preferably designed as a motor vehicle, in particular as a passenger car or truck, or as a passenger bus or motorcycle.

With regard to the embodiments of the motor vehicle and the battery cell system and the associated advantages, reference is made to the previously described embodiments of the housing device and the corresponding advantages.

The invention also includes combinations of the features of the embodiments described. The invention thus also comprises implementations which each have a combination of the features of several of the embodiments described, provided that the embodiments have not been described as mutually exclusive.

### BRIEF DESCRIPTION OF THE FIGURES

Exemplary embodiments of the invention are described below. In particular:

FIG. 1 shows a schematic perspective view of an embodiment of a housing device;

FIG. 2 shows a schematic side sectional view of an embodiment of the housing device from FIG. 1;

FIG. 3 shows a schematic perspective view of an embodiment of a second local weakening from FIG. 2; and

FIG. 4 shows a schematic side sectional view of the second local weakening from FIG. 3.

### DETAILED DESCRIPTION

The embodiments described below are preferred embodiments of the invention. In the exemplary embodiments, the described components of the embodiments each represent individual features of the invention which are to be considered independently of each other and which also further form the invention independently of each other. Therefore, the disclosure is also intended to include combinations of the features of the embodiments other than those shown. Furthermore, the described embodiments can also be supplemented by further features of the invention already described.

In the figures, identical reference numerals denote elements with the same function.

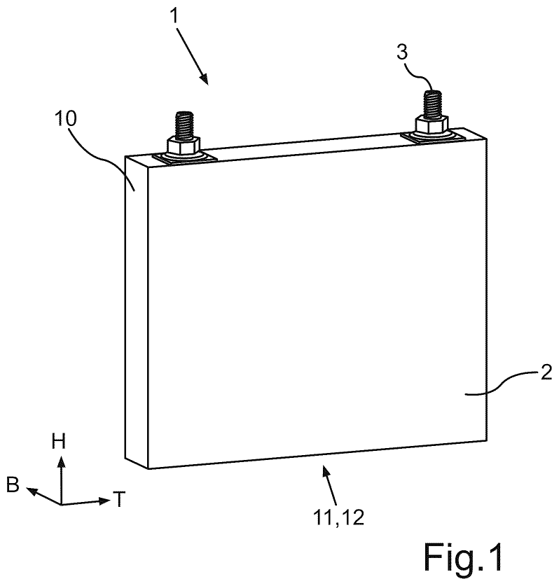

FIG. 1 shows a schematic perspective view of an embodiment of a housing device 1.

The housing device 1 forms an enclosure for a battery cell 2 arranged inside the housing device 1 and comprises a housing 10, which is designed to enclose the battery cell 2, as well as a first and a second local weakening 11 and 12, which are arranged on the underside not shown in detail in this FIG. 1.

The housing 10 is essentially cuboid in shape and has a height H and depth T that are both greater than the width B.

The housing device also has two connection elements, of which only one connection element 3 is provided with a reference numeral for reasons of clarity. The connection elements are arranged on the side of the housing opposite to the first and second local weakening 11, 12.

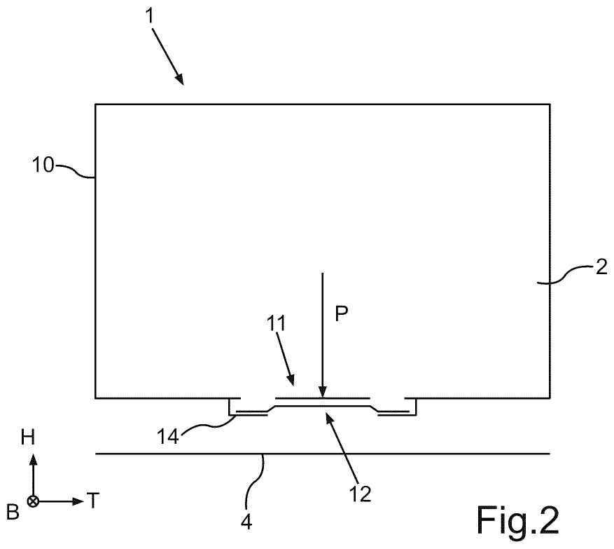

FIG. 2 shows a schematic side sectional view of an embodiment of the housing device 1 of FIG. 1.

The arrangement of the first and second local weakening 11 and 12 is shown in detail. The first local weakening 11 and the second local weakening 12 are both located on an underside of the housing device, opposite an underride guard 4, which forms the bottom or lower end of a motor vehicle.

The first local weakening 11 and the second local weakening 12 are arranged one above the other along a height H of the housing device 1 and have essentially the same shape and extent. The first local weakening 11 and the second local weakening 12 are designed to overlap or cover each other along a width B and a depth T.

The first local weakening 11 is designed to yield at a first pressure P generated by the battery cell 2 and the second local weakening 12 is designed to yield at a second pressure P generated by the battery cell 2, the second pressure being lower than the first pressure.

The second local weakening 12 is offset inwards at least in portions relative to the rest of the housing 10 with respect to the first local weakening 11. For this purpose, the second local weakening 12 has an offset. The second local weakening 12 is held or fastened to the housing 10 by means of a retaining element 14.

The pressure P and associated hot gas as well as particles that have formed inside the housing 10 due to the battery cell 2 are thus dissipated in the direction of the underride guard 4, first by yielding of the first local weakening 11 and then by yielding of the second local weakening 12. There they are cooled down and when they are reflected by the underride guard 4 and collide with another housing device according to the invention and in particular a second local weakening arranged there, this efficiently protects against penetration into the interior of the housing and thus thermal expansion of a second battery cell.

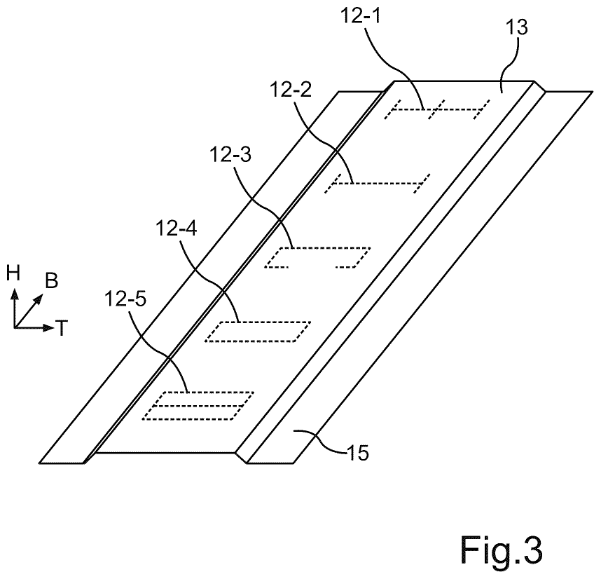

FIG. 3 shows a schematic perspective view of an embodiment of a second local weakening from FIG. 2.

Various embodiments of second local weakenings 12 are shown in FIG. 3. The second local weakenings 12 have one or more predetermined breaking points, which are indicated in this Fig. by a dashed line. The local weakenings 12 are shown as essentially rectangular.

The first embodiment of the second local weakening 12-1 has a total of four predetermined breaking points, two of which coincide with the short sides of the second local weakening 12-1 and two further coincide with the central normals of the long and short sides of the second local weakening 12-1 and thus form a cross.

The second embodiment of the second local weakening 12-2 has a total of three predetermined breaking points, two of which coincide with the short sides of the second local weakening 12-2 and a further one with the central normal of the short sides, which runs parallel to the long sides of the second local weakening 12-1.

The third embodiment of the second local weakening 12-3 has a total of five predetermined breaking points, three of which coincide with sides of the second local weakening 12-3, namely two with the short sides and one with a long side. The two further predetermined breaking points extend at least in portions along the second long side of the second local weakening 12-3.

The fourth embodiment of the second local weakening 12-4 has a total of four predetermined breaking points, all four of which coincide with one side of the second local weakening 12-3, namely two with the short sides and two with the long sides.

The fifth embodiment of the second local weakening 12-5 has a total of five predetermined breaking points, four of which coincide with all sides of the second local weakening 12-3, namely two with the short sides and two with the long sides. The fifth predetermined breaking point runs along the central normal of the short sides, which runs parallel to the long sides of the second local weakening 12-3.

The local weakenings 12 are covered by a sealing element 13, which is shown here as an example as a film and seals the localized weakenings or the predetermined breaking points inwards.

It is to be noted that the same or different second predetermined breaking points 12 can be provided for multiple housing devices arranged next to each other or one behind the other in the direction of the width B.

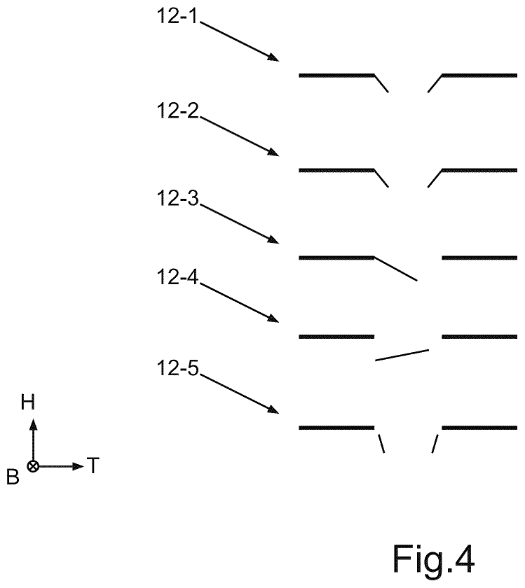

How these second local weakenings 12 yield when subjected to pressure P is explained in connection with the following FIG. 4.

FIG. 4 shows a schematic side sectional view of the second local weakening from FIG. 3.

The first embodiment of the second local weakening 12-1 folds downwards from two sides in the opposite direction to the height H.

The second embodiment of the second local weakening 12-2 also folds downwards from two sides in the opposite direction to the height H.

The third embodiment of the second local weakening 12-3 only folds downwards on one side in the opposite direction to the height H.

The fourth embodiment of the second local weakening 12-4 is detached all around and pressed away in the opposite direction to the height H, wherein the film shown in FIG. 3 holds the detached element in place.

The fifth embodiment of the second local weakening 12-5 is detached all around and in two parts and pressed away in the opposite direction to the height H, wherein the film shown in FIG. 3 holds the detached element in place.

Overall, the examples show how vent openings in a high-voltage cell stack can be effectively protected against thermal propagation in the event of a malfunction.

1. A housing device for a battery cell, comprising:
a housing which is designed to enclose a battery cell;
a first localized weakening adapted to yield at a first pressure generated by the battery cell; and
a second local weakening which is arranged at least partially above the first local weakening and which is designed to yield in the event of a second pressure generated by the battery cell, wherein the second pressure is lower than the first pressure.

2. The housing device according to claim 1, wherein the second local weakening has a predetermined breaking point.

3. The housing device according to claim 1, wherein the second local weakening has a substantially rectangular shape and wherein at least one side of the rectangular shape is designed as a predetermined breaking point.

4. The housing device according to claim 3, wherein at least three sides of the rectangular shape are designed as a predetermined breaking point.

5. The housing device according to claim 3, wherein all sides of the rectangular shape are designed as a predetermined breaking point.

6. The housing device according to claim 1, further comprising a sealing element which extends over and seals the second local weakening.

7. The housing device according to claim 1, wherein the second local weakening is offset relative to the remaining housing towards the first local weakening.

8. The housing device according to claim 1, wherein the first local weakening consists of a different material than the second local weakening.

9. A battery cell system, comprising at least two housing devices according to claim 1, which are arranged next to each other, wherein in particular each of the housing devices comprises a battery cell.

10. A motor vehicle, comprising a housing device according to claim 1.

11. The housing device according to claim 2, wherein the second local weakening has a substantially rectangular shape and wherein at least one side of the rectangular shape is designed as a predetermined breaking point.

12. The housing device according to claim 4, wherein all sides of the rectangular shape are designed as a predetermined breaking point.

13. The housing device according to claim 2, further comprising a sealing element which extends over and seals the second local weakening.

14. The housing device according to claim 3, further comprising a sealing element which extends over and seals the second local weakening.

15. The housing device according to claim 4, further comprising a sealing element which extends over and seals the second local weakening.

16. The housing device according to claim 5, further comprising a sealing element which extends over and seals the second local weakening.

17. The housing device according to claim 2, wherein the second local weakening is offset relative to the remaining housing towards the first local weakening.

18. The housing device according to claim 3, wherein the second local weakening is offset relative to the remaining housing towards the first local weakening.

19. The housing device according to claim 4, wherein the second local weakening is offset relative to the remaining housing towards the first local weakening.

20. The housing device according to claim 5, wherein the second local weakening is offset relative to the remaining housing towards the first local weakening.
